(19) United States
(12) Patent Application Publication
(10) Pub. No.: US 2025/0015263 A1
(43) Pub. Date: Jan. 9, 2025

(54) METHOD FOR PRODUCING SECONDARY BATTERY

(71) Applicant: SEMICONDUCTOR ENERGY LABORATORY CO., LTD., Atsugi-shi (JP)

(72) Inventors: Atsushi KAWATSUKI, Yokohama (JP); Naoto OKUZAWA, Atsugi (JP); Mayumi MIKAMI, Atsugi (JP); Yohei MOMMA, Isehara (JP)

(21) Appl. No.: 18/763,866

(22) Filed: Jul. 3, 2024

(30) Foreign Application Priority Data
Jul. 7, 2023 (JP) 2023-112205

(51) Int. Cl. H01M 4/36; H01M 4/02; H01M 4/38; H01M 4/58; H01M 4/60

(52) U.S. Cl. CPC H01M 4/364; C08J 7/08; H01M 4/38; H01M 4/5815; H01M 4/606; C08J 2361/06; H01M 2004/028

(57) ABSTRACT

One embodiment of the present invention is to provide a high-capacity lithium ion secondary battery and a production method thereof. To perform surface modification, a spherical resin is subjected to first heat treatment at a temperature higher than or equal to 500° C. in an inert atmosphere. By the heating, the contraction of a particle, the void formation due to a gas release from an inside of the particle, the crack on a particle surface, and the like are caused so as to form a support for sulfur that is to be mixed later. Obtained spherical particles and sulfur powder are mixed and then stored in a container. The mixture in the container is subjected to second heat treatment at a temperature higher than or equal to 120° C. without being exposed to outside air.

### BACKGROUND OF THE INVENTION

### 1. Field of the Invention

One embodiment of the present invention relates to an object, a method, or a manufacturing method. Another embodiment of the present invention relates to a process, a machine, manufacture, or a composition of matter. Another embodiment of the present invention relates to a power storage device, a semiconductor device, a display device, a light-emitting device, a lighting device, an electronic device each including a secondary battery, or a manufacturing method thereof.

Note that electronic devices in this specification mean all devices including power storage devices, and electro-optical devices including power storage devices, information terminal devices including power storage devices, and the like are all electronic devices.

Note that a power storage device in this specification refers to every element and device having a function of storing electric power. For example, a power storage device (also referred to as a secondary battery) of a lithium-ion secondary battery, a lithium-ion capacitor, and an electric double layer capacitor are included.

### 2. Description of the Related Art

In recent years, a variety of power storage devices, such as lithium-ion secondary batteries, lithium-ion capacitors, and air batteries, have been actively developed. In particular, demand for lithium-ion secondary batteries with high output and high energy density has rapidly grown with the development of the semiconductor industry, for portable information terminals typified by mobile phones, smartphones, or laptop computers, portable music players, digital cameras, medical equipment, and next-generation clean energy vehicles typified by hybrid electric vehicles (HVs), electric vehicles (EVs), and plug-in hybrid electric vehicles (PHVs), and the lithium-ion secondary batteries are essential as rechargeable energy supply sources for today's information society.

Furthermore, lightweight and high-capacity secondary batteries have been desired, and the attention has been paid on secondary batteries in which a material containing a sulfur element is used as a positive electrode active material. It is known that sulfur has a high theoretical capacity, approximately 1670 mAh/g, and is a promising material as a positive electrode active material in terms of the energy density.

In addition, materials containing a sulfur element are abundantly present as resources, which causes an advantage that such a material is cheaper than a rare metal such as cobalt.

For example, research on secondary batteries using sulfur and graphene sponge (3DGS) as secondary batteries using sulfur (also referred to as lithium-sulfur batteries or Li-S batteries) has been done (Non-Patent Document 1).

### REFERENCE

### Non-Patent Document

[Non-Patent Document 1] Chao Lin et al., “A facile synthesis of three dimensional graphene sponge composited with sulfur nanoparticles for flexible Li-S cathodes”, Phys. Chem. Chem. Phys., 2016, 18, 22146-22153

### SUMMARY OF THE INVENTION

In a secondary battery using a material containing a sulfur element as a positive electrode active material, a lithium metal as an example of a negative electrode active material is used. At the time of discharging, the lithium metal in the negative electrode is dissolved in an electrolyte solution to be an ion, and the ion reacts with sulfur in the positive electrode to be oxidized, so that a reaction intermediate product, lithium polysulfide (Li₂Sₙ (2≤n≤8)), is formed and then followed by lithium sulfide (Li₂S).

An object of one embodiment of the present invention is to provide a lithium-ion secondary battery with high capacity and a production method thereof. Another object of one embodiment of the present invention is to provide a lightweight and high capacity lithium-ion secondary battery and a production method thereof.

Another object of one embodiment of the present invention is to provide a lithium-ion secondary battery that has high charge and discharge cycle performance and a production method thereof. Another object of one embodiment of the present invention is to provide a lithium-ion secondary battery with a long cycle life and a high degree of safety or reliability and a production method thereof.

Note that the description of these objects does not preclude the existence of other objects. One embodiment of the present invention does not need to achieve all of these objects. Other objects can be derived from the description of the specification, the drawings, and the claims.

To perform surface modification, a spherical resin is subjected to first heat treatment at a temperature higher than or equal to 500° C. in an inert atmosphere. The contraction of a particle, the void formation due to a gas release from an inside of the particle, the crack on a particle surface, and the like are caused in the spherical resin by the heating so as to form a support for sulfur that is to be mixed later.

By the first heat treatment, the particle-size distribution or the resistance component of the spherical resin is changed. Thus, a preferred heating condition is to narrow the particle-size distribution and reduce the resistance. As specific conditions, the first heat treatment is performed in an inert atmosphere, at a temperature higher than or equal to 500° C. and lower than or equal to 1000° C., for a time period greater than or equal to 2 hours and less than or equal to 10 hours, preferably performed at 650° C. for 4 hours.

A spherical particle is obtained by heating the spherical resin. This spherical particle is a porous particle at least part of which is carbonized. Alternatively, the whole of the particle may be carbonized. The average particle diameter of the spherical particle obtained by heating with the above heating conditions is small, whereas the Brunauer-Emmett-Teller (BET) specific surface area of the spherical particle is significantly large. Since the BET specific surface area after the first heat treatment is increased, it is presumed that the surface of the spherical particle is modified to have a plurality of depressions or pores. The spherical particle that has been subjected to the heating can also be referred to as a phenol resin at least part of which is carbonized.

The BET specific surface area is measured with an automated specific surface area analyzer TriStar II 3020. The BET method is an analytical method in which Langmuir's theory of adsorption is extended to multilayer adsorption of adsorbed gas molecules, which is the most common method for calculating the specific surface area.

After the obtained spherical particle and sulfur powder are mixed, the mixture is stored in a container and subjected to second heat treatment at a temperature higher than or equal to 120° C. without being exposed to outside air.

When the temperature of the second heat treatment is higher than or equal to 120° C., which is equal to or higher than a temperature at which sulfur volatilizes or sublimates, it is important to store the mixture in a container with a lid so as to prevent gasified sulfur from leaking to the outside of the container. Furthermore, the container may be fully sealed with the lid, or it is not necessary that the container be sealed fully. In the case where the second heat treatment is performed in a state where the container is not fully sealed, the amount of sulfur after the second heat treatment is reduced as compared with that before the second heat treatment. Considering the reduced amount, the amount of sulfur powder to be mixed is adjusted.

After that, grinding is performed to obtain a sulfur compound including a plurality of spherical particles inside or on its surface. This is a positive electrode active material.

FIG. 3A shows an SEM image of a mixture, and FIG. 3B is a schematic view thereof where a plurality of spherical particles 302 are embedded in one lump 309 of a sulfur compound and a plurality of spherical particles are attached to the surface of the lump of the sulfur compound.

A secondary battery using a mixture obtained by the above production method as one of materials in a positive electrode active material layer is also one embodiment of the present invention, and the positive electrode active material layer includes a conductive additive and a binder. To form the positive electrode active material layer, slurry is formed by mixing the mixture, a solvent, the conductive additive (conductive material), and the binder and then applied on a positive electrode current collector.

A heat treatment condition such that sulfur in the positive electrode active material layer is less likely to be vaporized is preferably employed for heat treatment performed under reduced pressure for drying the applied positive active material layer. A specific condition is such that the temperature is higher than or equal to 40° C. and lower than 80° C. and a treating time is greater than or equal to one hour and less than 24 hours.

The secondary battery that is a lithium-sulfur battery includes a positive electrode, a negative electrode, a separator, and an electrolyte. The positive electrode includes the positive electrode current collector and the positive electrode active material layer provided over the positive electrode current collector.

In the above structure, the negative electrode is a lithium metal.

A secondary battery using sulfur for a positive electrode and a lithium metal for a negative electrode can be lightweight and can have high capacity. The secondary battery obtained through the above production process can be stable for a long time and is less likely to cause a short circuit or heat generation of the battery; thus, the secondary battery can achieve high safety. The secondary battery obtained through the above production process has high charge and discharge efficiency and an improved lifetime of the secondary battery.

One embodiment of the present invention can provide a lithium-ion secondary battery with high capacity and a manufacturing method thereof. Another embodiment of the present invention can provide a lightweight and high-capacity lithium-ion secondary battery, and a manufacturing method thereof.

Another embodiment of the present invention can provide a lithium-ion secondary battery with high charge and discharge cycle performance and a production method thereof. Another embodiment of the present invention can provide a secondary battery with a long life cycle and a high degree of safety or reliability and a production method thereof.

Note that the description of these effects does not preclude the existence of other effects. One embodiment of the present invention does not necessarily have all of these effects. Other effects will be apparent from and can be derived from the description of the specification, the drawings, the claims, and the like.

### BRIEF DESCRIPTION OF THE DRAWINGS

FIG. 1 is an example of a flowchart showing a production process of one embodiment of the present invention.

FIG. 2 is an example of a flowchart showing a production process of one embodiment of the present invention.

FIG. 3A is an SEM image showing one embodiment of the present invention, and FIG. 3B is a schematic view of FIG. 3A.

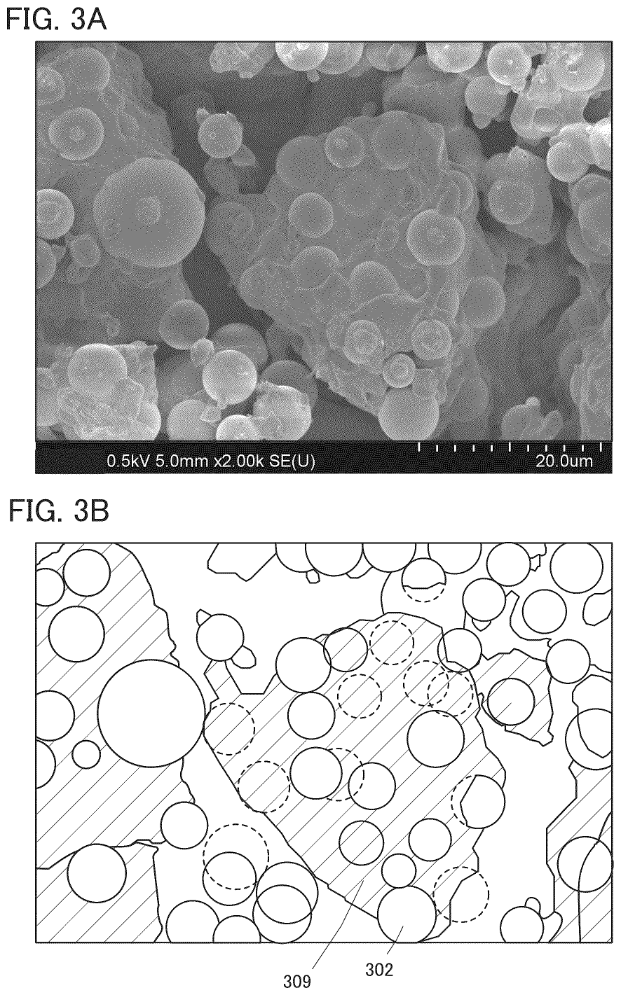

FIG. 4A is an exploded perspective view of a coin-type secondary battery, FIG. 4B is a perspective view of the coin-type secondary battery, and FIG. 4C is a cross-sectional perspective view thereof.

FIGS. 5A to 5D illustrate examples of electronic devices.

FIGS. 6A to 6C illustrate examples of electronic devices.

FIGS. 7A to 7C illustrate examples of vehicles.

FIGS. 8A and 8B illustrate an examples of an electric bicycle.

FIG. 9 shows charge and discharge characteristics.

FIG. 10 shows cycle performance.

FIG. 11A is an example of a schematic cross-sectional view of a spherical resin particle, and FIGS. 11B to 11D are each an example of a schematic cross-sectional view of a spherical particle.

### DETAILED DESCRIPTION OF THE INVENTION

Hereinafter, embodiments of the present invention will be described in detail with reference to the drawings. Note that the present invention is not limited to the description below, and it is easily understood by those skilled in the art that modes and details of the present invention can be modified in various ways. In addition, the present invention should not be construed as being limited to the description in the following embodiments.

In this specification and the like, the terms “first” and “second” are sometimes used for easy understanding of the technical contents or identification of components.

Thus, the terms “first” and “second” do not limit the number of components. In addition, the terms “first” and “second” do not limit the order of components. In addition, the terms or identification numerals such as “first” and “second” used in this specification do not correspond to the terms or the identification numerals in the scope of claims of this application in some cases.

### Embodiment 1

In this embodiment, a production process up to the formation of a positive electrode active material layer over a positive electrode current collector is described below.

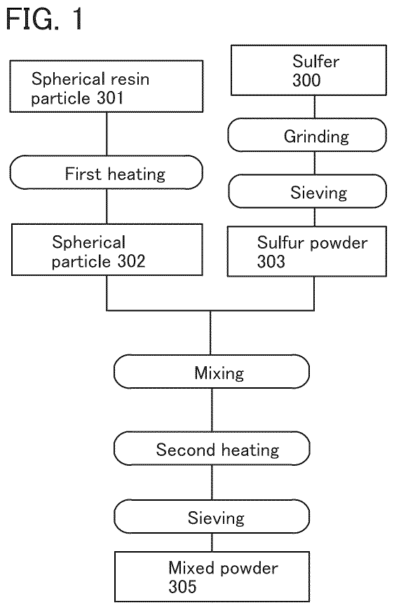

FIG. 1 is an example of a flowchart of a production process of a positive electrode active material.

First, a spherical resin particle 301 is prepared and subjected to first heating for surface modification. “Spherical” that is a shape of the spherical resin particle 301 refers to one or more shapes selected from a true spherical shape, an elliptical shape, and a spherical shape including a plurality of depressions. The spherical resin particle 301 may have a projection or a depression on part of its surface. The shape of the spherical resin particle 301 can be observed with an electron microscope.

Although there is no particular limitation on the spherical resin particle 301, a phenol resin is used here. The spherical resin particle 301 can be obtained in the following manner: phenols including polyhydric phenols and aldehydes are synthesized through condensation reaction, and a phenol resin is separately collected.

D50 of the spherical resin particle 301 is preferably greater than or equal to 5 μm and less than or equal to 10 μm. This is because the particle within this range has high mechanical strength and easily maintains its spherical shape. In addition, the particles within the above range are less likely to be aggregated to form a lump when the slurry is formed, and thus the slurry is easily applied. Damage to the particles in a later step of pressing at the time of forming a positive electrode active material layer is inhibited. Note that D50 refers to a particle diameter whose cumulative distribution of calculated particle size is 50%. The particle size may be calculated by measuring the major diameter of the cross section of the particle obtained by analysis with a SEM, a transmission electron microscope (TEM), or the like, instead of using laser diffraction particle size distribution measurement. Note that an example of a method for measuring D50 with a SEM, TEM, or the like includes a method for measuring 20 or more particles to make a cumulative particle size distribution curve, and setting a particle diameter when the accumulation of particles accounts for 50% as D50.

The spherical resin particle 301 is subjected to the first heating for surface modification at a temperature higher than or equal to 500° C. and lower than or equal to 1000° C. for a time range greater than or equal to 2 hours and less than or equal to 10 hours. In this embodiment, the first heat treatment is performed at 650° C. in a nitrogen atmosphere for 4 hours. The spherical resin particle 301 becomes blackened after the heat treatment, which means that at least part of the surface of the spherical resin particle 301 is carbonized. By the first heating, atoms such as oxygen or hydrogen contained in the spherical resin particle 301 are released, and thus carbonization or pore formation is caused. Powder obtained through this heating is a spherical particle 302.

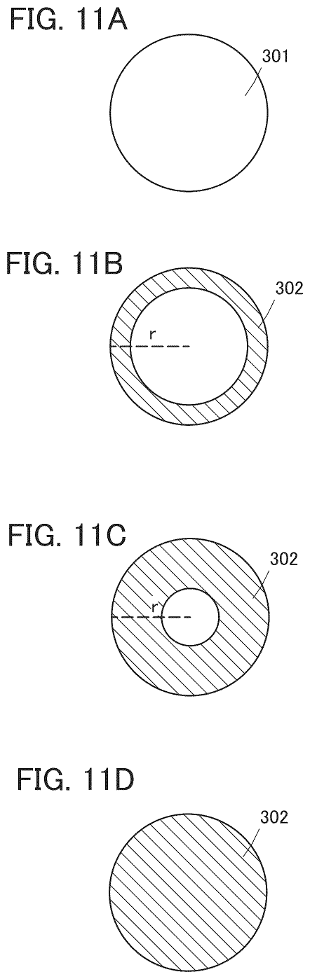

A schematic cross-sectional view of the spherical resin particle 301 is illustrated in FIG. 11A. Variations of the spherical particle 302 obtained by the first heat treatment are illustrated in FIGS. 11B to 11D. The spherical resin particle 301 is an organic compound, and its carbonating process is very complicated. Composition varies by the carbonation. When the organic compound is heated, atoms such as oxygen, hydrogen, or nitrogen, other than carbon, are released, and the organic compound is carbonated. By the heat treatment, the organic compound is turned into any one or more of states illustrated in FIGS. 11B to 11D, depending on the material of the spherical resin particle 301 or the condition of the first heat treatment. FIG. 11B illustrates the state where only a surface portion of the spherical resin particle 301 is carbonized, and the carbonized range is less than half of a radius r of the spherical resin particle 301. FIG. 11C illustrates the state where the spherical resin particle 301 other than its center portion is carbonated, and the carbonized range of the spherical resin particle 301 is more than or equal to the radius r. FIG. 11D is an example where most part of the spherical resin particle 301 is carbonized, which illustrates the state where most part is turned into porous carbon. The state illustrated in FIG. 11D can be referred to as graphite when the spherical particle 302 has such a structure that a number of regular six-membered rings of carbon atoms are connected on a plane. Needless to say, the graphite in this case is not natural graphite but artificial graphite. The degree of graphitization can be measured with a high-resolution electron microscope image, an X-ray diffraction method, or the like. In the present invention, at least part of the surface of the spherical resin particle 301 is preferably carbonized by the first heating so as to be easily bonded to sulfur to be mixed later.

Sulfur 300 is prepared to mix the spherical particle 302 and sulfur powder 303. The sulfur 300 that is commercially available is ground in an argon atmosphere, and then made to pass through a sieve (with an aperture size of 53 μm) to prepare the sulfur powder 303. High purity sulfur is preferable for the sulfur 300, and sulfur whose purity is higher than or equal to 99.999% is used. With use of an agate mortar, the mixing is performed so that the weight ratio of the sulfur 300 to the spherical particle 302 is higher than or equal to 30% and lower than or equal to 50%.

Next, the spherical particle 302 and the sulfur powder 303 are mixed. Then, second heat treatment is performed. For the second heat treatment, the mixture is stored in a container, an alumina boat, that is covered with aluminum foil as a lid. The alumina boat that is covered is put into a tube furnace, and heating with an argon gas flowing is performed at a temperature higher than or equal to 150° C. and lower than or equal to 160° C. for a time range greater than or equal to 3 hours and less than or equal to 20 hours. In this embodiment, the second heat treatment is performed at 155° C. for 6 hours. Since sulfur is easily evaporated, it is preferable to perform heating in a state where the container containing sulfur is covered with a lid. The container is not limited to an alumina boat. The powder wrapped with aluminum foil may be put into a cylindrical metal container that can be fully sealed and then be heated in an argon atmosphere.

Through the second heating, the sulfur powder 303 and the spherical particle 302 are bonded to each other to form the lump 309. The lump is ground and passes through a sieve (with an aperture size of 53 μm), whereby mixed powder 305 can be obtained. In the mixed powder 305, a plurality of spherical particles 302 are present on the surface or in the inside of the lump 309 of sulfur.

The obtained mixed powder 305 was attached to indium foil for SEM observation. Energy dispersive X-ray spectroscopy (EDX) analysis was performed at several points. As a result, it was confirmed that sulfur was detected in the surface portion of the spherical particle, and the sulfur was held in the pore in the surface portion.

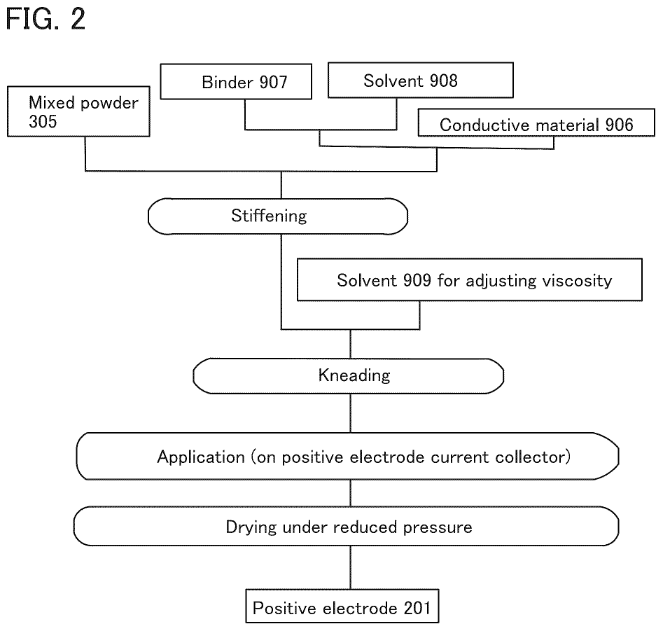

Next, slurry used for forming the positive electrode active material layer over the positive electrode current collector is formed. FIG. 2 illustrates part of a flowchart of the production process of the positive electrode active material layer.

Slurry refers to a mixture which contains at least a positive electrode active material and a solvent 908 and in which one or both of a binder 907 and a conductive material 906 are mixed. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

The binder 907 is also referred to as a binding agent. Since the binder 907 is a resin, a large amount of binder 907 lowers the proportion of the active material in the positive electrode, thereby reducing the discharge capacity of the secondary battery. Therefore, the amount of binder 907 mixed is reduced to a minimum.

As the conductive material 906, one or more kinds of carbon, copper, tin, zinc, silver, and nickel can be used. Typical examples of the carbon material used as the conductive material 906 include carbon black (e.g., furnace black, particulate carbon such as acetylene black, and graphite). In this embodiment, acetylene black (AB) is used as the conductive material 906, for example.

As the binder 907, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, poly(vinylidene fluoride) (PVDF), polyacrylonitrile (PAN), ethylene-propylene-diene polymer, polyvinyl acetate, or nitrocellulose is preferably used. Alternatively as the binder 907, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Further alternatively, fluororubber can be used as the binder 907.

As the solvent 908, N-methylpyrrolidone (NMP) or acetone is used. The viscosity of the slurry material can be adjusted as appropriate with the amount of the solvent, a reaction temperature, or reaction time.

The binder 907 is dissolved in the solvent 908, and the mixed powder 305 and the conductive material 906 are mixed therein, whereby slurry is formed. The viscosity of the slurry material is adjusted as appropriate with the amount of the solvent 908 or a solvent 909, a reaction temperature, or reaction time. For example, the solvent 909 in a stiffen state, NMP in this embodiment, is added to perform kneading. Degassing is performed if necessary.

The thus obtained slurry is applied on the positive electrode current collector. For the current collector, aluminum foil coated with carbon is used.

Next, drying is performed under reduced pressure. Drying for volatilizing the solvent can be performed by a method such as ventilation drying or reduced pressure (vacuum) drying. Drying is performed at a temperature higher than or equal to 50° C. and lower than 120° C. Pressing may be performed if necessary.

Through the above process, a positive electrode 201 can be obtained.

### Embodiment 2

An example of producing a secondary battery using the positive electrode 201 obtained in Embodiment 1 will be described below.

The secondary battery includes at least the positive electrode 201, an electrolyte, a separator, and a negative electrode.

### Electrolyte

The secondary battery includes an electrolyte containing carrier ions. The electrolyte in this specification and the like is not limited to an electrolyte containing an organic solvent that is liquid at room temperature but includes a solid electrolyte and an electrolyte (a semisolid electrolyte) containing both an organic solvent that is liquid at room temperature and a solid electrolyte that is a solid at room temperature. Note that an electrolyte obtained by dissolving lithium salt in an organic solvent that is liquid at room temperature is sometimes referred to as an electrolyte solution.

An issue of a secondary battery using sulfur is that battery characteristics significantly depend on the formation and dissolution of lithium polysulfide. During discharge, lithium polysulfide (Li₂S_{X}, X is greater than or equal to 2 and less than or equal to 8) is generated, which reduces the capacity. During charge, lithium polysulfide causes the shuttle reaction, which significantly reduces the charge and discharge efficiency. Most of organic solvents react with lithium polysulfide.

The organic solvent that is liquid at room temperature is preferably an aprotic organic solvent. As an ether-based electrolyte solution, 1,3-dioxolane (DOL), 1,2-dimethoxyethane (DME), or sulfolane (SL) can be used. As a fluorinated ether-based electrolyte solution, 1,1,2,2-tetrafluoroethyl (TTE) or bis(2,2,2-trifluoromethyl) ethyl (BTFE) can be used. Furthermore, glymes such as methyl monoglyme, ethyl monoglyme, butyl diglyme, triglyme, or tetraglyme can be used as an electrolyte solution.

There is no particular limitation on a lithium salt dissolved in the above organic solvent as long as it can be used for known lithium-sulfur batteries. For example, LiCl, LiPF₆, LiSCN, or lithium bis(trifluoromethane)sulfonimide (LiTFSI) can be used.

### Additive

The above-described organic solvent may contain an additive. As the additive, lithium nitrate, an imide salt, a sulfonated compound, an aromatic compound, or a halogen-substituted product of any of these can be used, for example.

### Separator

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramics-based material, a fluorine-based material, a polyamide-based material, a mixture thereof, or the like. Examples of the ceramics-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramics-based material, the oxidation resistance is improved; hence, deterioration of the separator in high-voltage charging and discharging can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With use of a separator having a multilayer structure, the discharge capacity per volume of the secondary battery can be increased because the safety of the secondary battery can be maintained even when the total thickness of the separator is small.

### Negative Electrode

The negative electrode includes a negative electrode active material layer and a negative electrode current collector.

### Negative Electrode Active Material

As the negative electrode active material, for example, a lithium metal or an alloy material (an alloy with copper, tin, or cobalt) can be used.

### Negative Electrode Current Collector

For the negative electrode current collector, as well as copper, a material similar to that of the positive electrode current collector can be used.

### Coin-Type Secondary Battery

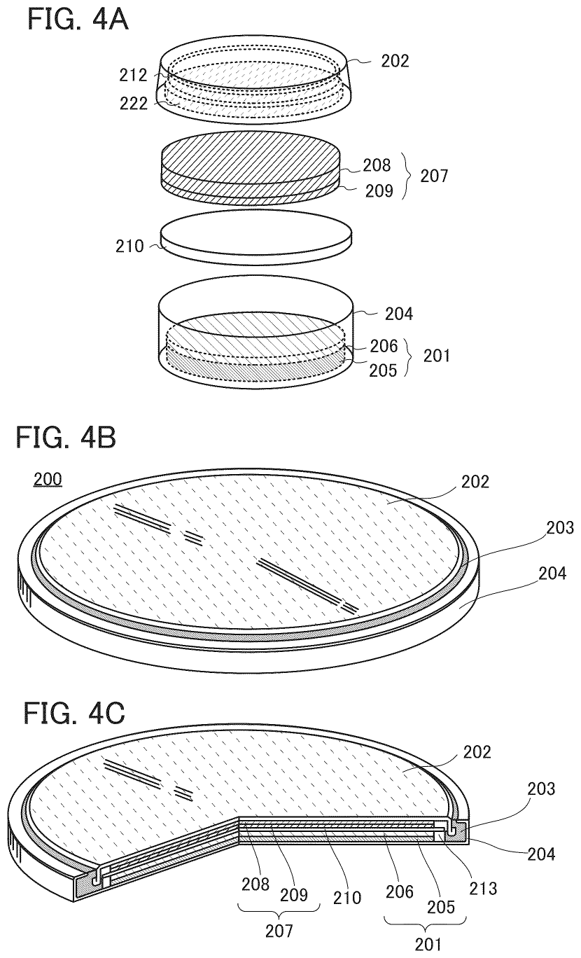

FIG. 4A, FIG. 4B, and FIG. 4C are an exploded perspective view, an external view, and a cross-sectional view of a coin-type (single-layer flat) secondary battery, respectively. The coin-type secondary battery is mainly used in a small electronic device.

For easy understanding, FIG. 4A is a schematic view illustrating overlap (a vertical relation and a positional relation) between components. Thus, FIG. 4A and FIG. 4B do not completely correspond with each other.

In FIG. 4A, a positive electrode 201, a separator 210, a negative electrode 207, a spacer 222, and a washer 212 are overlaid. They are sealed with a negative electrode can 202, a positive electrode can 204, and a gasket. Note that the gasket for sealing is not illustrated in FIG. 4A. The spacer 222 and the washer 212 are used to protect the inside or fix the position of the components inside the cans at the time when the positive electrode can 204 and the negative electrode can 202 are bonded with pressure. For the spacer 222 and the washer 212, stainless steel or an insulating material is used.

The positive electrode 201 is a stack in which a positive electrode active material layer 206 is formed over a positive electrode current collector 205.

FIG. 4B is a perspective view of a completed coin-type secondary battery.

In a coin-type secondary battery 200, the positive electrode can 204 serving also as a positive electrode terminal and the negative electrode can 202 serving also as a negative electrode terminal are insulated and sealed with a gasket 203 formed of polypropylene or the like. The positive electrode 201 is formed of a positive electrode current collector 205 and a positive electrode active material layer 206 which is provided to be in contact with the positive electrode current collector 205. The negative electrode 207 is formed of a negative electrode current collector 208 and a negative electrode active material layer 209 which is provided to be in contact with the negative electrode current collector 208. The negative electrode 207 is not limited to having a stacked-layer structure, and lithium metal foil or lithium-aluminum alloy foil may be used.

Note that only one surface of each of the positive electrode 201 and the negative electrode 207 used for the coin-type secondary battery 200 is provided with an active material layer.

For the positive electrode can 204 and the negative electrode can 202, a metal having corrosion resistance to an electrolyte solution, such as nickel, aluminum, or titanium, an alloy of such a metal, or an alloy of such a metal and another metal (e.g., stainless steel) can be used. The positive electrode can 204 and the negative electrode can 202 are preferably covered with nickel, aluminum, or the like in order to prevent corrosion due to the electrolyte solution, for example. The positive electrode can 204 and the negative electrode can 202 are electrically connected to the positive electrode 201 and the negative electrode 207, respectively.

The negative electrode 207, the positive electrode 201, and the separator 210 are immersed in the electrolyte solution. Then, as illustrated in FIG. 4C, the positive electrode can 204, the positive electrode 201, the separator 210, the negative electrode 207, and the negative electrode can 202 are stacked in this order with the positive electrode can 204 positioned at the bottom, and the positive electrode can 204 and the negative electrode can 202 are subjected to pressure bonding with the gasket 203 interposed therebetween. In such a manner, the coin-type secondary battery 200 is manufactured.

With the above structure, the coin-type secondary battery 200 can have high capacity, high discharge capacity, and excellent cycle performance.

### Embodiment 3

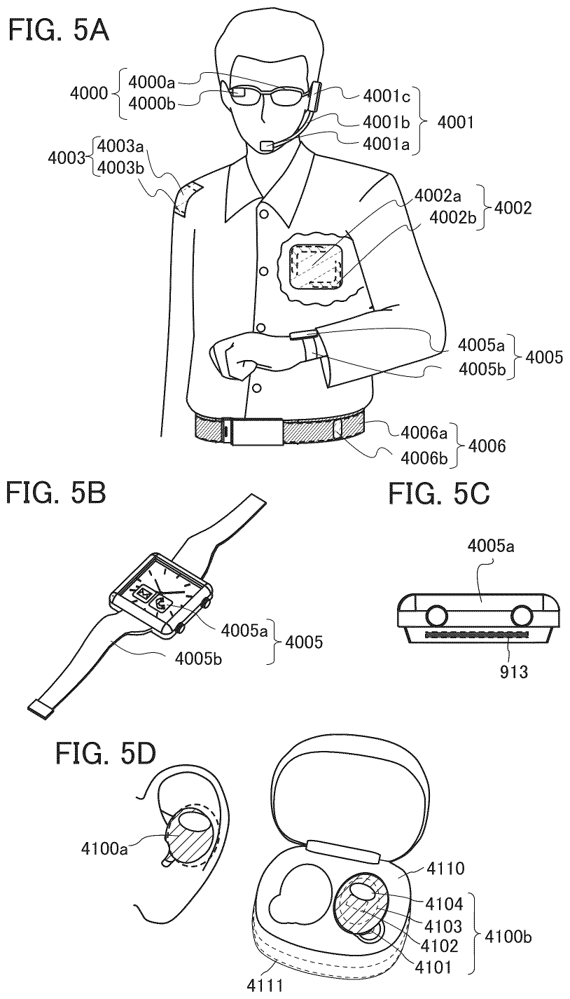

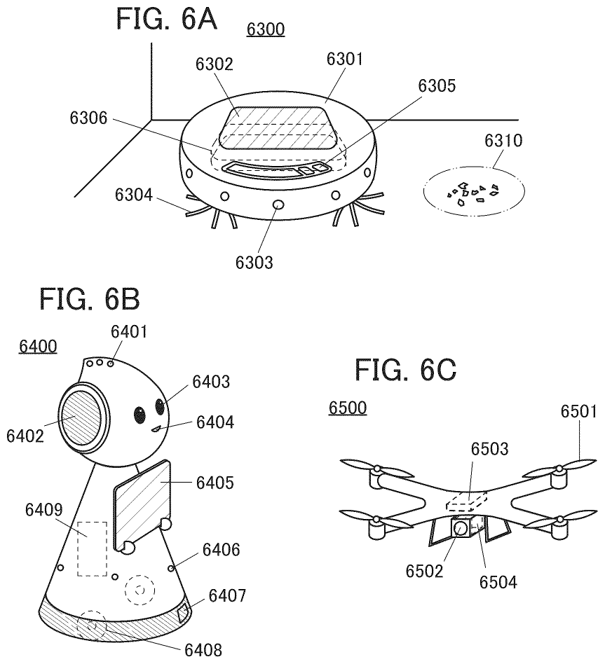

In this embodiment, examples of electronic devices each including the secondary battery of one embodiment of the present invention will be described with reference to FIGS. 5A to 5C and FIGS. 6A to 6C.

FIG. 5A illustrates examples of wearable devices. A lightweight and high-capacity secondary battery is used as a power source of each wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 5A. The glasses-type device 4000 includes a frame 4000a and a display part 4000b. The secondary battery is provided in a temple of the frame 4000a having a curved shape, whereby the glasses-type device 4000 can be lightweight, can have a well-balanced weight, and can be used continuously for a long time. With use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone part 4001a, a flexible pipe 4001b, and an earphone portion 4001c. The lightweight and high-capacity secondary battery can be provided in the flexible pipe 4001b and/or the earphone portion 4001c. With use of the secondary battery of one embodiment of the present invention, space saving required with downsizing of a housing can be achieved.

The secondary battery of one embodiment of the present invention can be provided in a device 4002 that can be attached directly to a body. A lightweight and high-capacity secondary battery 4002b can be provided in a thin housing 4002a of the device 4002. With use of the secondary battery of one embodiment of the present invention, space saving required with downsizing of a housing can be achieved.

The secondary battery of one embodiment of the present invention can be provided in a device 4003 that can be attached to clothes. A lightweight and high-capacity secondary battery 4003b can be provided in a thin housing 4003a of the device 4003. With use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the lightweight and high-capacity secondary battery can be provided inside the belt portion 4006a. With use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the lightweight and high-capacity secondary battery can be provided in the display portion 4005a or the belt portion 4005b. With use of the secondary battery of one embodiment of the present invention, space saving required with downsizing of a housing can be achieved.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 5B is a perspective view of the watch-type device 4005 that is detached from an arm.

FIG. 5C is a side view thereof. FIG. 5C illustrates a state where a secondary battery 913 is incorporated in the watch-type device 4005. The secondary battery 913, which is small and lightweight, overlaps with the display portion 4005a.

FIG. 5D illustrates an example of wireless earphones. The wireless earphones shown as an example consist of, but not limited to, a pair of earphone bodies 4100a and 4100b.

The earphone bodies 4100a and 4100b include a driver unit 4101, an antenna 4102, and a secondary battery 4103. The earphone bodies 4100a and 4100b may also include a display portion 4104. Moreover, the earphone bodies 4100a and 4100b preferably include a substrate where a circuit such as a wireless IC is provided, a terminal for charge, and the like. The earphone bodies 4100a and 4100b may also include a microphone.

A case 4110 includes a secondary battery 4111. Moreover, the case 4110 preferably includes a substrate where a circuit such as a wireless IC or a charge control IC is provided, and a terminal for charge. The case 4110 may also include a display portion, a button, and the like.

The earphone bodies 4100a and 4100b can communicate wirelessly with another electronic device such as a smartphone. Thus, sound data and the like transmitted from another electronic device can be played through the earphone bodies 4100a and 4100b. When the earphone bodies 4100a and 4100b include a microphone, sound captured by the microphone is transmitted to another electronic device, and sound data obtained by processing with the electronic device can be transmitted to and played through the earphone bodies 4100a and 4100b. Hence, the wireless earphones can be used as a translator, for example.

The secondary battery 4103 included in the earphone body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. The secondary battery obtained in Embodiment 1 is lightweight and has high capacity and high energy density; thus, the use of the secondary battery as the secondary battery 4103 and the secondary battery 4111 can contributes to space saving and a weight reduction due to downsizing of the wireless earphones can be achieved.

FIG. 6A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes the secondary battery 6306 of one embodiment of the present invention and a semiconductor device or an electronic component. The cleaning robot 6300 including the secondary battery 6306 of one embodiment of the present invention can be reduced in weight, and thus the cleaning robot 6300 can be an electronic device that can operate for a long time.

FIG. 6B illustrates an example of a robot. A robot 6400 illustrated in FIG. 6B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery 6409 of one embodiment of the present invention and a semiconductor device or an electronic component. The robot 6400 including the secondary battery of one embodiment of the present invention can be reduced in weight as a whole; and thus the robot 6400 can be an electronic device that can operate for a long time.

FIG. 6C illustrates an example of a flying object (also referred to as a drone). A flying object 6500 illustrated in FIG. 6C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 includes the secondary battery 6503 of one embodiment of the present invention. When the secondary battery of one embodiment of the present invention, which is lightweight and has high capacity, is used for the flying object 6500, the flying object 6500 can be reduced in weight as a whole; and thus, the flying object 6500 can operate for a long time. This embodiment can be implemented in appropriate combination with any of the other embodiments.

### Embodiment 4

In this embodiment, examples of vehicles each including the secondary battery of one embodiment of the present invention will be described.

The use of secondary batteries in vehicles enables production of next-generation clean energy vehicles such as hybrid vehicles (HV), electric vehicles (EV), and plug-in hybrid vehicles (PHV).

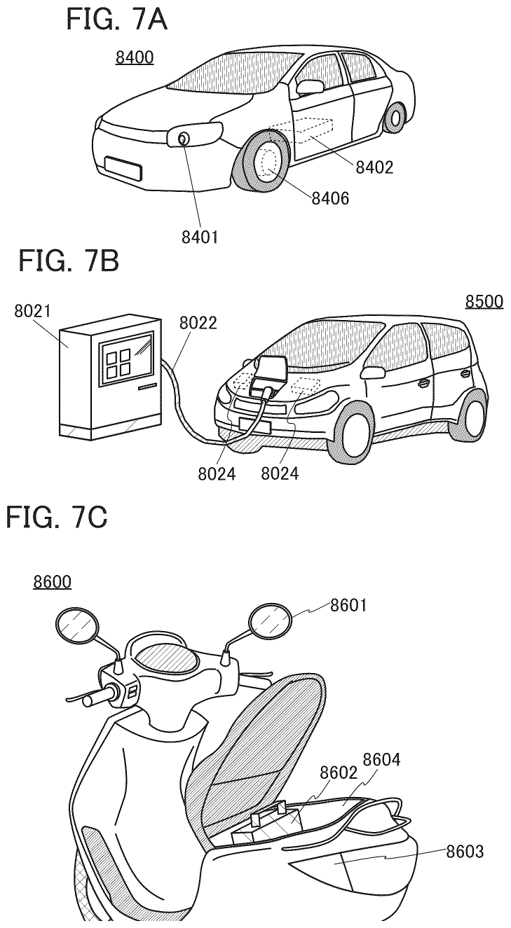

FIGS. 7A to 7C illustrate examples of vehicles each including the secondary battery of one embodiment of the present invention. An automobile 8400 illustrated in FIG. 7A is an electric vehicle that runs on the power of an electric motor. Alternatively, the automobile 8400 is a hybrid vehicle capable of driving using either an electric motor or an engine as appropriate. The use of one embodiment of the present invention allows fabrication of a high-mileage vehicle. The automobile 8400 includes a secondary battery 8402. For example, the modules of the secondary battery 8402 can be arranged in a floor portion in the automobile to be used. The secondary battery 8402 is used not only for driving an electric motor 8406, but also for supplying electric power to light-emitting devices such as a headlight 8401 and a room light (not illustrated).

The secondary battery can also supply electric power to a display device included in the automobile 8400, such as a speedometer and a tachometer. Furthermore, the secondary battery can supply electric power to a semiconductor device included in the automobile 8400, such as a navigation system.

FIG. 7B illustrates an automobile 8500 including the secondary battery. The automobile 8500 can be charged when the secondary battery is supplied with electric power from external charging equipment by a plug-in system and/or a contactless power feeding system, for example. In FIG. 7B, a secondary battery 8024 included in the automobile 8500 is charged with use of a ground-based charging apparatus 8021 through a cable 8022. In charging, a given method such as CHAdeMO (registered trademark) or Combined Charging System can be employed as a charge method, the standard of a connector, or the like as appropriate. The charging apparatus 8021 may be a charging station provided in a commerce facility or a power source in a house. For example, with use of a plug-in technique, the secondary battery 8024 included in the automobile 8500 can be charged by being supplied with electric power from the outside. The charge can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road and/or an exterior wall, charge can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops and/or moves. To supply electric power in such a contactless manner, an electromagnetic induction method and/or a magnetic resonance method can be used.

FIG. 7C illustrates an example of a motorcycle including the secondary battery of one embodiment of the present invention. A motor scooter 8600 illustrated in FIG. 7C includes a secondary battery 8602, side mirrors 8601, and indicators 8603. The secondary battery 8602 can supply electric power to the indicators 8603.

In the motor scooter 8600 illustrated in FIG. 7C, the secondary battery 8602 can be held in an under-seat storage unit 8604. The secondary battery 8602 can be held in the under-seat storage unit 8604 even with a small size. The secondary battery 8602 is detachable; thus, the secondary battery 8602 is carried indoors when charged, and is stored before the motor scooter is driven.

According to one embodiment of the present invention, the secondary battery can be lightweight and have an increased discharge capacity. Thus, the capacity per unit weight can be increased, so that the secondary battery itself can be made more compact and lightweight. The compact and lightweight secondary battery contributes to a reduction in the weight of a vehicle and thereby increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions.

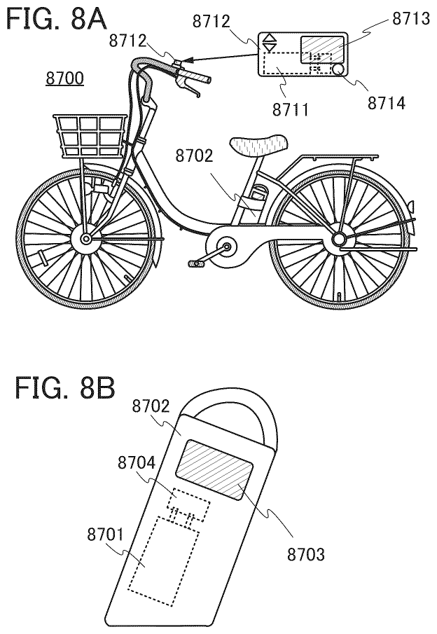

FIG. 8A illustrates an example of an electric bicycle using the secondary battery of one embodiment of the present invention. The secondary battery of one embodiment of the present invention can be used for an electric bicycle 8700 in FIG. 8A. A storage device of the electric bicycle 8700 of one embodiment of the present invention includes a plurality of secondary batteries and a charge/discharge control portion, for example.

The electric bicycle 8700 is provided with a power storage device 8702. The power storage device 8702 can supply electric power to a motor (electric motor portion) that assists a rider. The power storage device 8702 is portable, and the power storage device 8702 in FIG. 8B is detached from the bicycle and corresponds to the secondary battery unit. The power storage device 8702 incorporates a plurality of batteries 8701 and can display the remaining battery level on a display portion 8703. The power storage device 8702 includes a charge/discharge control portion 8704 capable of charge control or anomaly detection for the secondary battery. The charge/discharge control portion 8704 is electrically connected to a positive electrode and a negative electrode of the battery 8701. In addition, an electric vehicle body unit of the electric bicycle 8700 is provided with an operation portion 8712 at a steering wheel. The operation portion 8712 includes a display portion 8713, a power switch 8714, and a power storage device 8711.

Since a material of the secondary battery of one embodiment of the present invention is cheap, the cost for the electric bicycle 8700 can be significantly reduced.

This embodiment can be implemented in appropriate combination with any of the other embodiments.

### Example

This example shows results of a charge and discharge test performed on a coin cell fabricated for this example. Note that the present invention is not limited only to Example below.

A procedure for fabricating a battery cell using the mixed powder 305 obtained in Embodiment 1 as a positive electrode active material is described below. Note that description is made with reference to FIG. 1 and FIG. 2.

First, a spherical phenol resin (ocher powder) was subjected to first heating, so that spherical blackened particles were obtained. In this example, approximately 3.5 g of a spherical phenol resin (“Marilin” HF-008, Gun Ei Chemical Industry Co., Ltd.) was used. A 100-ml alumina crucible where the spherical phenol resin was put was covered with an alumina lid and put into a muffle furnace. The muffle furnace was used for the first heating for which the temperature rising process and the temperature lowering process were performed at 200° C. per hour. The first heating was performed at 650° C. for 4 hours in an inert atmosphere where a nitrogen gas was flowing. According to the comparison of the BET specific surface area of the spherical particle before and after the first heat treatment, the specific surface area before the heating was 0.332 m²/g whereas that after the heating was 525 m²/g; the specific surface area increased approximately by 1500 times. The median diameter remained almost unchanged before and after the first heat treatment (the median diameter before the heating was 7.92 μm; that after the heating was 6.67 μm). The above facts suggest that at least a surface of the spherical phenol resin be carbonized to form a pore. Note that the median diameter refers to a median diameter obtained by laser diffraction particle size distribution measurement.

Sulfur (5N, Strem Chemicals, Inc.) was ground in a glove box and made to pass through a sieve with an aperture size of 53 μm.

The spherical blackened particles and sulfur were weighed so that the weight ratio of spherical blackened particles to sulfur was 2:1, and then mixed in an agate mortar.

The mixed powder was transferred to an alumina boat, wrapped with aluminum foil, and subjected to second heating in a tube furnace. The second heating was performed at 155° C. for 6 hours in an argon atmosphere. The argon flow rate was 0.2 L/min. As the temperature rising process, the temperature was increased from 25° C. to 120° C. in 30minutes, and then increased to 155° C. taking one hour. The gradual temperature rising in the above manner enables an increase in temperatures to be achieved without significant deviation from a target temperature. After the heating at 155° C. for 6 hours, natural cooling was performed in an argon atmosphere. Although being wrapped with the aluminum foil, the mixed powder was not fully sealed; thus, part of the sulfur was volatilized by the heating and the amount thereof was reduced.

In a dry room, the mixed powder was ground with an agate mortar again and made to pass through a sieve with an aperture size of 53 μm, whereby an active material was obtained.

Slurry was formed under a condition where the ratio of the active material to acetylene black to PVDF was 8:1:1. The slurry was applied onto a positive electrode current collector. As the positive electrode current collector, carbon-coated aluminum foil (SDX-PM, Showa Denko Packaging Co., Ltd.) was used. The loading amount of the active material was approximately 2 mg/cm².

With use of a positive electrode containing sulfur obtained in the above manner, a coin cell (using an aluminum clad can for a positive electrode can) was fabricated. Note that the aluminum clad can refers to a can whose inside is coated with aluminum. Aluminum clad can is used in the case where a material of a housing such as a positive electrode can might chemically react with an electrolyte solution, to prevent corrosion due to the electrolyte solution.

Furthermore, lithium metal foil was used for a negative electrode, and glass fiber filter paper (GF/C) was used for a separator. Furthermore, LiTFSI was used as a lithium salt, DOL/DME was used as an electrolyte solution, and 0.1M LiNO₃ was used as an additive to be added to an electrolyte solution where LiTFSI was adjusted to have 1.0 M.

A cycle test was performed on the obtained coin cell to measure charge and discharge characteristics and cycle performance.

Before the cycle test, the battery cell was discharged at room temperature (25° C.) and a discharge rate of 10 mA/g with a constant current (CC mode) until the voltage reached 1.4 V, followed by charging at a charge rate of 10 mA/g with a constant current (CC mode) until the voltage reached 2.8 V.

Note that in the calculation of the discharge rate and the charge rate, the weight of the active material (containing the weight of the spherical blackened particle as the active material) was used. In this specification, sulfur or a sulfur compound functions as an active material, and a spherical blackened particle is a conductive material for making the active material with conductivity, but the spherical blackened particle is regarded to fall into the category of the positive electrode active material. In some cases, the positive electrode active material refers to only sulfur itself or a sulfur compound; in such a case, the total weight of the sulfur itself or the sulfur compound may be measured, and the capacity per weight may be calculated. The positive electrode active material contains fine particles of a sulfurized active material attached to at least part of the spherical blackened particle that is a conductive material. The fine particle of the active material is sulfur itself, lithium disulfide, or lithium polysulfide.

After constant current charge (CC mode) was performed until the voltage reached 2.8 V, a 10-minute break was taken, constant current discharge was performed at a discharge rate of 10 mA/g until the voltage reached 1.4 V (also referred to as a cutoff voltage), and then constant current charge was performed at a charge rate of 10 mA/g until the voltage reached 2.8 V. A 10-minute break was taken after the above charge and discharge.

After that, as the first discharge in the cycle test, constant current discharge was performed at room temperature (25° C.) and a discharge rate of 10 mA/g until the voltage reached 1.4 V, and then as the first charge in the cycle test, constant current charge was performed at a charge rate of 10 mA/g until the voltage reached 2.8 V. A set of this discharge and charge was regarded as one cycle, and 50 cycles were performed. Note that a 10-minute break was taken between the cycles.

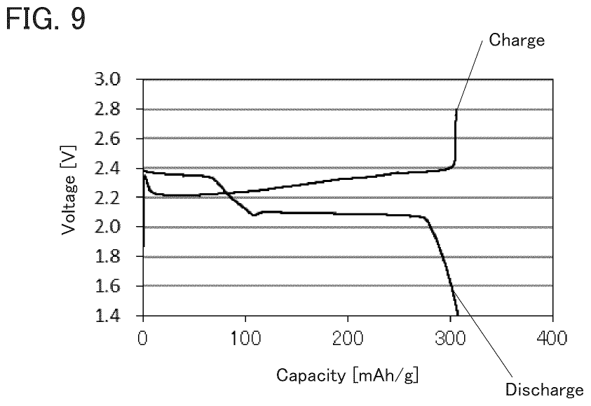

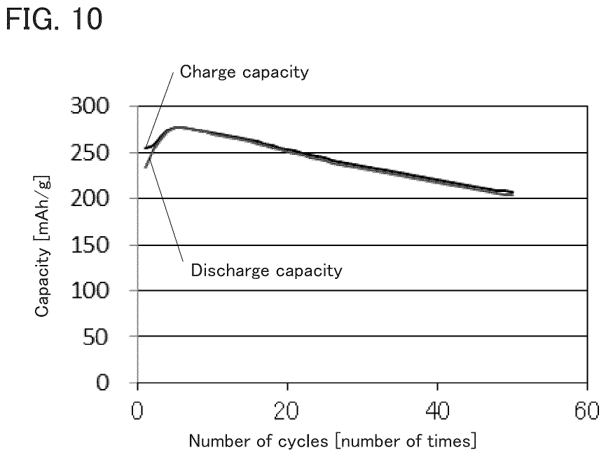

The obtained charge and discharge characteristics are shown in FIG. 9, and the obtained cycle performance is shown in FIG. 10. Note that in FIG. 9, the vertical axis represents voltages [V], and the horizontal axis represents capacity [mAh/g]. In FIG. 10, the vertical axis represents capacity [mAh/g], and the horizontal axis represents cycle performance [number of times].

The maximum value of the charge capacity of the coin cell in this example is approximately 306 mAh/g, and that of the discharge capacity is approximately 307 mAh/g. As shown in FIG. 9, the charge and discharge characteristics are better. The capacity retention rate is 74.3%. As shown in FIG. 10, the cycle performance is high.

In this specification, “cycle performance” refers to a characteristic where the charge and discharge capacity of a secondary battery is retained even when a set of charge and discharge is repeated under certain conditions. Thus, it can be said that a secondary battery whose decreasing rate of the charge and discharge capacity in accordance with the number of charge and discharge repeated (also referred to as the number of cycles) is low has high capacity retention rate and good cycle performance.

This application is based on Japanese Patent Application Serial No. 2023-112205 filed with Japan Patent Office on Jul. 7, 2023, the entire contents of which are hereby incorporated by reference.

What is claimed is:

1. A method for producing a secondary battery, comprising:
performing a first heat treatment on a spherical resin at a temperature higher than or equal to 500° C. in an inert atmosphere to perform surface modification;
mixing a spherical particle, the spherical particle comprising at least a part of a surface carbonized, and sulfur powder to form a mixture; and
performing a second heat treatment on the mixture at a temperature higher than or equal to 120° C. without being exposed to outside air to form a positive electrode active material,
wherein the mixture is stored in a container when the second heat treatment is performed.

2. The method for producing a secondary battery according to claim 1,
wherein the container comprises a lid, and
wherein the container is covered with the lid during the second heat treatment.

3. The method for producing a secondary battery according to claim 1, wherein the second heat treatment is performed in an inert atmosphere.

4. The method for producing a secondary battery according to claim 1, wherein the spherical particle is a phenol resin comprising at least a part of a surface carbonized.

5. The method for producing a secondary battery according to claim 1, wherein a BET specific surface area of the spherical particle after the first heat treatment is larger than a BET specific surface area of the spherical particle before the first heat treatment.

6. The method for producing a secondary battery according to claim 1, wherein before the second heat treatment, a weight proportion of the sulfur powder is higher than a weight proportion of the spherical particle.

7. The method for producing a secondary battery according to claim 1,
wherein the container comprises a lid,
wherein the container storing the mixture is fully sealed with the lid in the second heat treatment, and
wherein the second heat treatment is performed in an inert atmosphere.

8. A method for producing a secondary battery, comprising:
performing a first heat treatment on a spherical resin at a temperature higher than or equal to 500° C. in an inert atmosphere to form a spherical particle;
mixing the spherical particle and sulfur powder to form a mixture; and
performing a second heat treatment on the mixture at a temperature higher than or equal to 120° C. without being exposed to outside air to form a positive electrode active material,
wherein the mixture is stored in a container when the second heat treatment is performed.

9. The method for producing a secondary battery according to claim 8, wherein at least a part of a surface of the spherical particle is carbonized.

10. The method for producing a secondary battery according to claim 8,
wherein the container comprises a lid, and
wherein the container is covered with the lid during the second heat treatment.

11. The method for producing a secondary battery according to claim 8, wherein the second heat treatment is performed in an inert atmosphere.

12. The method for producing a secondary battery according to claim 8, wherein the spherical particle is a phenol resin comprising at least a part of a surface carbonized.

13. The method for producing a secondary battery according to claim 8, wherein a BET specific surface area of the spherical particle after the first heat treatment is larger than a BET specific surface area of the spherical particle before the first heat treatment.
